(19) United States
(12) Patent Application Publication
(10) Pub. No.: US 2008/0167943 A1
(43) Pub. Date: Jul. 10, 2008

(54) Real time pricing, purchasing and auctioning of advertising time slots based on real time viewership, viewer demographics, and content characteristics

(76) Inventors: Douglas R. O'Neil, Marietta, GA (US); Robert A. Koch, Norcross, GA (US); William Smith, Marietta, GA (US)

Correspondence Address: SCOTT P. ZIMMERMAN, PLLC, PO BOX 3822, CARY, NC, 27519, US

(21) Appl. No.: 11/650,235

(22) Filed: Jan. 5, 2007

(51) Int. Cl. G06Q 30/00; G06Q 10/00

(52) U.S. Cl. 705/10; 705/14

(57) ABSTRACT

An exemplary advertising auction tool includes advertising data, detailed auction data such as pricing to bid on an advertisement time slot and desirable viewership characteristics and metrics, and business data for awarding the advertisement time slot and for distributing the advertisement. The auction tool receives near real-time viewership data about a viewer's selection and use of media content and matches the viewership data with the advertising data to identify one or more advertisements as desirable for distribution during the advertisement time slot. The auction tool then establishes a bid price for each of the matched advertisements. These bid prices are then automatically adjusted by the advertising auction tool based upon comparisons of the matched data for each advertisement and based upon the business data for each advertisement. Thereafter, the auction tool awards the advertisement time slot to maximize a contract price for the advertisement time slot.

### CROSS REFERENCE TO RELATED APPLICATIONS

This application relates to commonly assigned co-pending U.S. patent application Ser. No. 10/017,640 entitled “System and Method for Identifying Desirable Subscribers,” (Attorney Docket BS01342) filed on Dec. 14, 2001, and of which is incorporated herein by reference.

This application relates to commonly assigned co-pending U.S. patent application Ser. No. ______ entitled “System and Method for Identifying Desirable Subscribers,” (Attorney Docket BS01342CON) filed on Dec. 8, 2006, and of which is incorporated herein by reference.

This application relates to commonly assigned co-pending U.S. patent application Ser. No. 11/154,248 entitled “Method and System for Tracking Network Use,” (Attorney Docket BS95003CON-2) filed on Jun. 16, 2005, and of which is incorporate herein by reference.

### NOTICE OF COPYRIGHT PROTECTION

A portion of the disclosure of this patent document and its figures contain material subject to copyright protection. The copyright owner has no objection to the facsimile reproduction by anyone of the patent document or the patent disclosure, but otherwise reserves all copyrights whatsoever.

### BACKGROUND OF THE INVENTION

This invention generally relates to data processing and, more particularly, to electronic negotiation and acquisition of media advertising based on real-time or near real-time viewership information.

Advertisers, content creators, and content distributors strive to identify desirable viewers and to identify how many viewers receive content. For example, traditional television and cable content providers derive substantial revenues from advertising. During the broadcast of a television program, advertisements, in the form of commercials, are inserted at various time intervals (also referred to a “time slots”). An advertiser pays the broadcaster to insert the advertisement during the time slot of the broadcast program.

The amount of money that an advertiser pays is typically related to the number of viewers watching, accessing, or otherwise selecting content with the highest distribution of the advertisement content. For conventional television advertising, advertising revenue equals a rate per thousand viewers multiplied by the number of viewers estimated to be viewing a program. For Internet and on-demand content, advertising revenue may look to a number of factors, such as a fixed amount per advertising impression, a percentage of revenue derived from a viewer ordering a product (or service) via a link to the web site hosting the advertisement and media content, and other models.

In addition, an advertiser may utilize a variety of viewer surveys and automated monitoring systems that attempt to characterize the viewer, record content choices and changes, and provide the information to a clearinghouse or other facility for further processing. The provider may enlist a ratings company to perform the monitoring and processing. For example, Nielsen Media Research (Nielsen Media Research, Inc., New York, N.Y.), Arbitron (Arbitron Inc., New York, N.Y.), and MeasureCast (MeasureCast, Inc., Portland, Oreg.) provide third-party monitoring and processing capability for television, radio, and Internet content.

Various other methods are also used to determine the popularity of programming and the effectiveness of advertising. For example, advertising effectiveness is often measured in terms of viewer attitudes and subsequent viewer actions, such as purchases, inquiries, behavior changes, and other actions. Methods of obtaining these measures may include: focus group tests, post-advertising surveys questioning whether an advertisement was viewed, remembered and possible impact, and measures of product purchases or other indirect results that may indicate whether or not an advertising campaign has been successful in reaching a target audience.

Conventional systems and methods lack simple, effective, and efficient means for determining viewer characteristics, such as, for example geographic location and/or preferences of viewers. Conventional systems and methods also lack simple and efficient means for determining a reliable total number of viewers, the duration of viewing patterns, especially as those patterns are affected by a viewer characteristic or the type of media content, the time-of-day of the media content delivery, and simultaneously delivery of media and advertisement content or delivery of integrated content. There is, accordingly, a need in the art for an easy-to-use procurement tool that structures an advertisement auction using near real-time viewership information, such as viewer patterns, preferences, and characteristics. There is also a need in the art for a procurement tool that teaches a subscriber how to strategically optimize an advertising auction to optimize the expected outcome.

### SUMMARY

The aforementioned problems, and other problems, are reduced, according to exemplary embodiments, by methods, systems, computer programs, and computer program products that access and analyze detailed auction data (also referred to herein as “auction data”), near real-time viewership data (also referred to herein as “viewership data”), advertising data, and business data for bid pricing of an advertisement slot and for awarding the advertisement time slot to a matched advertisement. Additionally, some of the embodiments include methods, computer systems, computer programs, and computer program products that recommend a structure to optimize a real-time advertising auction.

According to exemplary embodiments, a near real-time advertising auction engine awards an advertisement time slot based upon near real-time viewership data. The advertising auction engine includes advertising data (e.g., advertisement content, advertisement metadata, advertisement characteristics, and other data), detailed auction data such as pricing to bid on an advertisement time slot and desirable viewership characteristics and metrics for bidding on an advertisement time slot (e.g., data provided by an advertiser for bidding on one or more advertisement time slots), and business data for awarding the advertisement time slot and for distributing the advertisement (e.g., data provided by a content provider to select a bid for an advertisement time slot). The auction engine receives near real-time viewership data about a viewer's selection and use of media content provided by a content provider. The viewership data describes at least one viewership criterion that is used to characterize the viewer as a desirable viewer for receiving the advertisement content (e.g., demographic information, genre, geographic location, etc.). The viewership data may be aggregated or otherwise collected to categorize the characteristics of the entire audience, to provide near real-time statistics on the size of the audience, and to identify additional criterion of the audience. The auction engine matches the viewership data with the advertising data and the auction data to identify one or more advertisements as desirable for distribution to the one or more viewers during the advertisement time slot. Next, the auction engine establishes a bid pricing for each of the matched advertisements. The bid pricing is automatically adjusted by the advertising auction engine based upon comparisons of the matched data for each advertisement and based upon the business data for each advertisement. Thereafter, the auction engine awards the advertisement time slot to maximize a contract price for the advertisement time slot.

In further exemplary embodiments, the auction engine or another component of the content distribution network merges the advertisement content with the media content for the awarded advertisement time slot. The integrated content is then distributed to a media delivery device of the viewer. Alternatively, the advertisement content may be distributed simultaneously with the media content or via alternative methods as discussed further below.

According to still further exemplary embodiments, the advertising auction engine comprises a revenue sharing engine that may include additional rules for calculating advertising revenue to a content provider for the award of the advertisement time slot. For example, the auction engine may include a rule for estimating revenue based upon a percentage of interactive viewer sales if the matched advertisement is presented during the advertisement time slot. And, the contract price would include the bid price and the estimated revenue. Or the advertiser tracks the revenues associated with the sales of a product that was advertised using the advertisement auction system and pays the advertisement auction company a share of the revenues. Another rule may include consideration of a weighting factor or adjustment factor by a content provider to influence the award of the advertisement time slot.

Other embodiments of this invention describe a computer program product. A computer-readable medium stores a Real Time Advertising Auction Module. The Auction Module prompts a user to input details of the advertising auction. Further, this computer software is easy to use. The advertiser simply enters or otherwise selects basic information regarding the advertising auction. Further, some of the embodiments include presentation of a summary of previous inputs and advertising results for future bidding.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### DESCRIPTION OF THE DRAWINGS

These and other features, aspects, and advantages of the embodiments of the present invention are better understood when the following Description is read with reference to the accompanying drawings, wherein:

FIG. 1 is a schematic illustrating an exemplary operating environment according to some of the embodiments;

FIG. 2 illustrates a block diagram of an operating system according to exemplary embodiments;

FIG. 3 is a schematic illustrating another exemplary operating environment according to some of the embodiments;

FIG. 4 illustrates exemplary system components, engines, and output according to some of the exemplary embodiments;

FIG. 5 is a schematic illustrating another exemplary operating environment according to some of the embodiments;

FIG. 6 is an exemplary graph illustrating selection of an advertisement based upon relative viewership metrics and pricing according to some of the exemplary embodiments;

FIGS. 7-9 are schematics illustrating exemplary Graphical User Interfaces according to some of the embodiments; and

FIGS. 10-11 are schematics illustrating yet another exemplary process for auctioning an advertisement time slot according to some of the embodiments.

### DESCRIPTION

This invention now will be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named manufacturer.

The exemplary embodiments of the near real-time advertising auction engine (also referred to herein as the “advertising auction tool,” the “auction tool”, “Real Time Advertising Auction Engine”, and “Auction Engine”) award an advertisement time slot based upon near real-time viewership data. The auction engine includes advertising data (e.g., advertisement content, advertisement metadata, advertisement characteristics, and other data), detailed auction data such as pricing to bid on an advertisement time slot and desirable viewership characteristics and metrics for bidding on an advertisement time slot (e.g., data provided by an advertiser for bidding on one or more advertisement time slots), and business data for awarding the advertisement time slot and for distributing the advertisement (e.g., data provided by a content provider to select a bid for an advertisement time slot, such as, minimum bid amount, volume pricing for a repeat advertiser, payment details (e.g., how to pay, when to pay, history of payment from a previous advertiser that may reflect credit history of advertiser), feedback mechanism for each advertiser that bids on a time slot and other business data). The auction engine receives near real-time viewership data about a viewer's selection and use of media content provided by a content provider. The viewership data describes at least one viewership criterion that is used to characterize the viewer as a desirable viewer for receiving the advertisement content (e.g., demographic information, genre, geographic location, etc.). The viewership data may be aggregated or otherwise collected to categorize the characteristics of the entire audience, to provide near real-time statistics on the size of the audience, and to identify additional criterion of the audience. The auction engine matches the viewership data with the advertising data and auction data to identify one or more advertisements as desirable for distribution to the one or more viewers during the advertisement time slot. Next, the auction engine establishes a bid pricing for each of the matched advertisements. The bid pricing is automatically adjusted by the advertising auction engine based upon comparisons of the matched data for each advertisement and based upon the business data for each advertisement. Thereafter, the auction engine awards the advertisement time slot to maximize a contract price for the advertisement time slot.

The exemplary embodiments of the auction engine enhance advertisement selection, pricing, and distribution for any content distribution system, including, for example, conventional cable television networks, wireless cable television networks, home satellite television networks, internet-based video stream delivery systems, hard disk download systems (in which a program is downloaded and viewed from a local hard disk for a limited amount of time—e.g., TiVo™ interactive television systems), “dumb terminal” systems (in which a head end possesses the intelligence and a device, such as a set-top box, passes key stroke information to the head end), and other content distribution systems that allow duplex communication (perhaps with the return path via a separate telephony network) to a set-top box coupled to a viewer's display device, such as a television. As used herein, the terms “media content” (also referred to herein as a “program”), “advertisement content” (also referred to herein as the “advertisement”), and “integrated, merged content” (e.g., the media content and the advertisement content) include any electronic information, such as, for example video, text, audio, and/or voice in a variety of formats, such as dual tone multi-frequency, digital, analog, and/or others. Additionally, these terms may include: (1) executable programs, such as a software application, (2) an address, location, and/or other identifier of the storage location for the media content, advertisement, or integrated content, and (3) integrated or otherwise combined electronic files, such as a grouping of media, advertisement content, billing programs, and/or others.

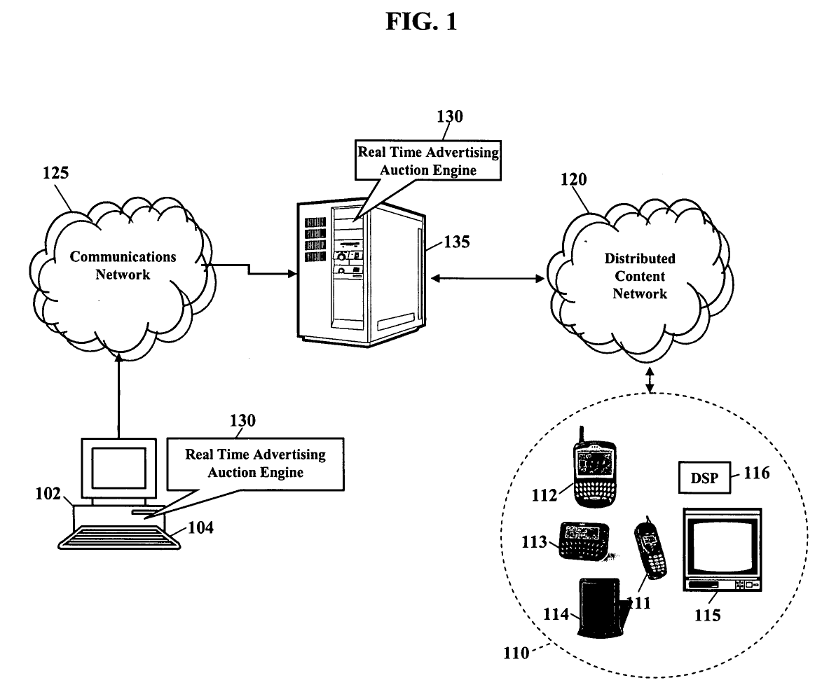

FIG. 1 is a schematic illustrating an exemplary operating environment that includes a Real Time Advertising Auction Engine 130 (also referred to herein as the “Auction Engine” and the “Auction Module”) to select and award an auctioned advertising time slot based upon near real-time viewership information. The Real Time Advertising Auction Engine 130 comprises methods, systems, computer programs, and/or computer program products. The Real Time Advertising Auction Engine 130 may operate within a computer system 102. When an advertiser desires to bid for one or more advertisement time slots for presentation of an advertisement, the Real Time Advertising Auction Engine 130 helps that advertiser optimize the expected outcome of the auction by matching near real-time viewership information with an advertisement to identify one or more desirable viewers and by providing more reliable viewership metrics (e.g., total number of viewers watching the media content). Further, according to exemplary embodiments, the Real Time Advertising Auction Engine 130 is a software program that guides the advertiser through various decisions that may impact the expected outcome of the advertisement auction. As used herein, the term “advertisement auction” includes a near real-time auction between one or more advertisers (or other entities interested in advertising or distributing other content during a media presentation) and one or more content providers. The advertisers bid against each other to win one or more available advertisement slots during presentation of the media content. The Real Time Advertising Auction Engine 130, then, is an easy-to-use procurement tool that structures an advertisement auction using near real-time viewership information, such as viewer patterns, preferences, and characteristics.

The Real Time Advertising Auction Engine 130 may operate locally and/or remotely. FIG. 1 shows the Real Time Advertising Auction Engine 130 locally stored/maintained within the computer system 102 that includes a keyboard 104, mouse (not shown), or other input device (e.g., a connected peripheral communications device) for accessing, inputting, and/or otherwise managing data of the Real Time Advertising Auction Engine 130. As FIG. 1 also shows, however, the Real Time Advertising Auction Engine 130 may also reside within another computer system, such as a computer server 135. The computer system 102 and the computer server 135 may communicate with each other via a communications network 125, such as the Internet (sometimes alternatively known as the “World Wide Web”), an intranet, a local-area network (LAN), and/or a wide-area network (WAN). As those of ordinary skill in the art understand, the Real Time Advertising Auction Engine 130 may be locally and/or remotely accessed by any computer system communicating with the communications network 125.

According to exemplary embodiments, the Real Time Advertising Auction Engine 130 structures an advertising auction that considers real-time viewership information. A distributed content network 120 delivers media content (and other content) to a media device 110 for presentation of the media content, such as an Atlanta Braves baseball game, to a viewer. The media device 110 may be any media presentation device, such as a cellular phone 111, a Voice over Internet Protocol (VOIP) phone 112, an interactive pager 113, a personal digital assistant (PDA) 114, a television 115, and any communications device having a digital signal processor (DSP) 116. The media device 110 may also include any computer, peripheral device, camera, modem, storage device, telephone, mobile phone, analog/digital recorder, CD/DVD player/recorder, audio equipment, receiver, tuner, and/or any other consumer multimedia device. The distributed content network 120 may be a television/cable network operating in the radio-frequency domain and/or the Internet Protocol (IP) domain. The communications network 120, however, may also include a distributed computing network, such as the Internet (sometimes alternatively known as the “World Wide Web”), an intranet, a satellite network, a telecommunications network (e.g., Public Switched Telephone Network, Mobile Switching Telephone Office, and others), a local-area network (LAN), and/or a wide-area network (WAN). The communications network 120 may include coaxial cables, copper wires, fiber optic lines, and/or hybrid-coaxial lines. The communications network 120 may even include wireless portions utilizing any portion of the electromagnetic spectrum and any signaling standard (such as the I.E.E.E. 802 family of standards). The communications address of the head end (or alternate delivery source of the program) may be an electronic data communications address, such as an email address, webpage, and/or an Internet Protocol (IP) associated address, and/or may be a telecommunications address, such as a telephone number or a communications address utilizing any frequency in the electromagnetic spectrum (e.g., short wave radio receiver).

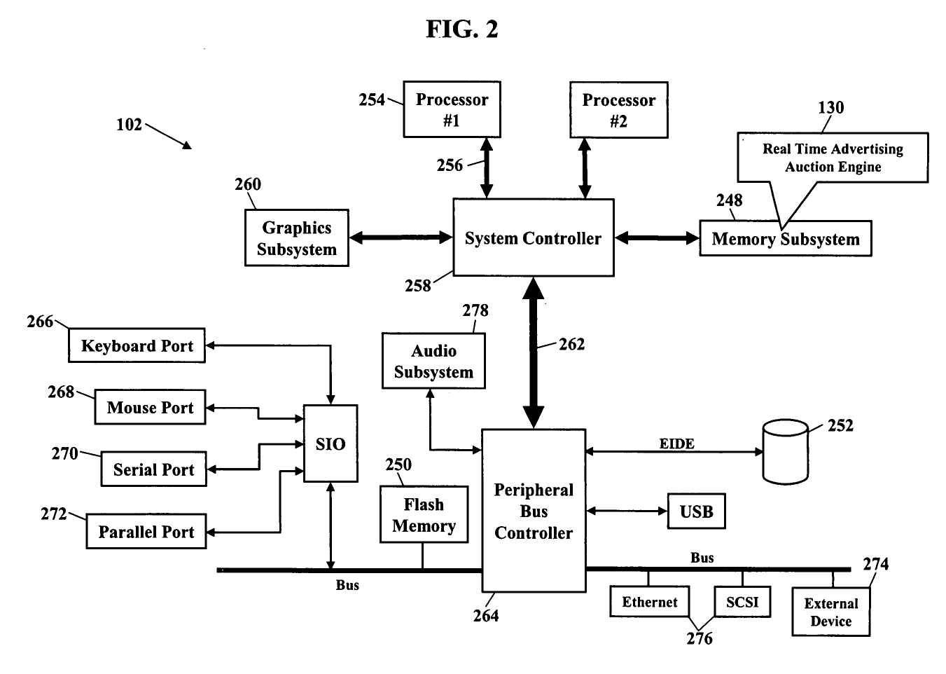

FIG. 2 illustrates an alternative operating environment for this invention. FIG. 2 is a block diagram showing the Real Time Advertising Auction Engine 130 residing in the computer system 102. However the Real Time Advertising Auction Engine 130 may be any computing system, such as the computer server 135 of FIG. 1. As FIG. 2 illustrates, the Real Time Advertising Auction Engine 130 operates within a system memory device. The Real Time Advertising Auction Engine 130, for example, is shown residing in a memory subsystem 248. The Real Time Advertising Auction Engine 130, however, could also reside in flash memory 250 or a peripheral storage device 252. The computer system 102 also has one or more central processors 254 executing an operating system. The operating system, as is well known, has a set of instructions that control the internal functions of the computer system 102. A system bus 256 communicates signals, such as data signals, control signals, and address signals, between the central processor 254 and a system controller 258 (typically called a “Northbridge”). The system controller 258 provides a bridging function between the one or more central processors 254, a graphics subsystem 260, the memory subsystem 248, and a PCI (Peripheral Controller Interface) bus 262. The PCI bus 262 is controlled by a Peripheral Bus Controller 264. The Peripheral Bus Controller 264 (typically called a “Southbridge”) is an integrated circuit that serves as an input/output hub for various peripheral ports. These peripheral ports are shown including a keyboard port 266, a mouse port 268, a serial port 270 and/or a parallel port 272 for a video display unit, one or more external device ports 274, and networking ports 276 (such as SCSI or Ethernet). The Peripheral Bus Controller 264 also includes an audio subsystem 278. Those of ordinary skill in the art understand that the programs, processes, methods, and systems described in this patent are not limited to any particular computer system or computer hardware. Other architectures are possible, and the Real Time Advertising Auction Engine 130 can operate in any architecture.

Those of ordinary skill in the art also understand the central processor 254 is typically a microprocessor. Advanced Micro Devices, Inc., for example, manufactures a full line of ATHLON™ microprocessors (ATHLON™ is a trademark of Advanced Micro Devices, Inc., One AMD Place, P.O. Box 3453, Sunnyvale, Calif. 94088-3453, 408.732.2400, 800.538.8450, www.amd.com). The Intel Corporation also manufactures a family of X86 and P86 microprocessors (Intel Corporation, 2200 Mission College Blvd., Santa Clara, Calif. 95052-8119, 408.765.8080, www.intel.com). Other manufacturers also offer microprocessors. Such other manufacturers include Motorola, Inc. (1303 East Algonquin Road, P.O. Box A3309 Schaumburg, Ill. 60196, www.Motorola.com), International Business Machines Corp. (New Orchard Road, Armonk, N.Y. 10504, (914) 499-1900, www.ibm.com), Sun Microsystems, Inc. (4150 Network Circle, Santa Clara Calif. 95054, www.sun.com), and Transmeta Corp. (3940 Freedom Circle, Santa Clara, Calif. 95054, www.transmeta.com). Those skilled in the art further understand that the program, processes, methods, and systems described in this patent are not limited to any particular manufacturer's central processor.

An exemplary operating system is DOS-based. That is, the exemplary operating system may be a WINDOWS-based operating system (WINDOWS® is a registered trademark of Microsoft Corporation, One Microsoft Way, Redmond Wash. 98052-6399, 425.882.8080, www.Microsoft.com). Any other operating system, however, is suitable with this invention. Some suitable operating systems include the UNIX® operating system (UNIX® is a registered trademark of the Open Source Group, www.opensource.org) and a LINUX® or a RED HAT® LINUX-based system (LINUX® is a registered trademark of Linus Torvalds, and RED HAT® is a registered trademark of Red Hat, Inc., Research Triangle Park, N.C., 1-888-733-4281, www.redhat.com). Still more suitable operating systems include the Mac® OS (Mac® is a registered trademark of Apple Computer, Inc., 1 Infinite Loop, Cupertino, Calif. 95014, 408.996.1010, www.apple.com). Those of ordinary skill in the art again understand that the programs, processes, methods, and systems described in this patent are not limited to any particular operating system.

The system memory device (shown as memory subsystem 248, flash memory 250, or peripheral storage device 252) may also contain an application program. The application program cooperates with the operating system and with a video display unit (via the serial port 270 and/or the parallel port 272) to provide a Graphical User Interface (GUI). The Graphical User Interface typically includes a combination of signals communicated along the keyboard port 266 and the mouse port 268. The Graphical User Interface provides a convenient visual and/or audible interface with a user of the computer system 102.

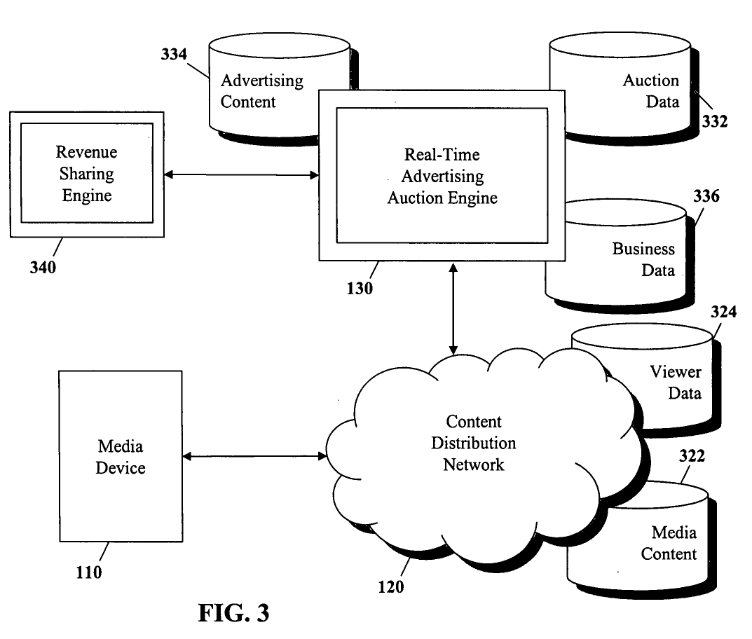

FIG. 3 illustrates another exemplary operating environment including the Real Time Advertising Auction Engine 130 coupled with or otherwise communicating with databases having auction data 332, business data 336, and advertising data 334, a Revenue Sharing Engine 340, the content distribution network 120 coupled with or otherwise communicating with databases having viewer data 324 and media content 322, and the media device 110. The viewer data 324 can be obtained through a number of means, such as the viewer provides the viewer data to his/her network service provider which can provide the viewer data to the advertising auction engine 130, or the viewer can choose to directly provide the viewer data to the advertising auction engine 130 through a registration process. The advertiser enters or otherwise provides auction data 332 to the Auction Engine 130 for bidding on an available time slot during presentation of media content to the media device 110. According to exemplary embodiments, the Auction Engine 130 accesses or otherwise retrieves viewership information from the content distribution network 120 to compare with the auction data 332 and with the advertising data 334 to identify “eligible” advertisements that match the auction criteria including viewership metrics, a viewership criterion, and/or a selected or otherwise targeted delivery of media content. For example, if Nike entered an advertisement auction for an advertisement slot during a sporting event for a selected date that has a minimum audience of 50,000 viewers without specifying a location of the target audience, then the Auction Engine 130 could access the content distribution network 120 to identify eligible sporting events, such as, for example, an Atlanta Braves baseball game, an Olympic broadcast, and a televised skateboarding contest in California—these media contents are directed at a sporting event without specifying a location of a target audience. However, the Auction Engine 130 still must search for a match that has a near real-time audience of 50,000 viewers. This near real-time viewership information may be deciphered by comparing two event records collected by the content distribution network 120, the media device 110, or components thereof.

An event is an action or a change in the state of the media device 110 that is deemed important to characterize the viewing selection(s) and/or use(s) by a viewer. For example, an event can include key presses to change channels or volume, mute, to enter a navigator for an interactive entertainment system, to turn the media device 110 off or on, to fast forward, to pause or to rewind a video obtained via the video on demand application. The event may also include an application invoked by the viewer, such as interactive gaming applications, an electronic program guide, a video on demand or near video on demand application, a home-shopping application or a particular company's interactive application, such as The Weather Channel's weather on demand, World Span's travel on demand or Light Span's educational interactive application. Events include viewer use of and control commands to peripheral devices coupled to the media device 110 or a viewer's display device, such as a VCR or videodisk player.

When an “event” of interest is detected, the content distribution network 120 (or alternate component) stores the event of interest and a corresponding time stamp in an event record. The content distribution network 120 then analyzes the viewer data and/or any near real time event records to characterize one or more viewership criterion. For example, the viewer data may describe the number of media devices that are “watching” or otherwise “viewing” the media content by deciphering and comparing at least two event records. That is, a first event record may include an event of interest to turn up the volume recorded at 9:53 PM and a second event record may include another event of interest to forward the media content presentation to a peripheral device coupled with the media device at 9:54 PM (e.g., forwarding the presentation of the media content from an IPTV to a VoIP phone). Consequently, the content distribution network 120 may decipher that the viewer is “watching” the media content and collectively count that viewer as a near real-time viewer of the media content. Still further, the content distribution network 120 may collectively gather each viewership criterion (e.g., age, sex, income, education) for an audience of a selected presentation of media content (e.g., men watching a broadcast of an Atlanta Braves baseball game). For example, the viewership data may be gathered as disclosed in commonly assigned co-pending U.S. patent application Ser. No. 11/154,248 entitled “Method and System for Tracking Network Use,” (Attorney Docket BS95003CON-2) filed on Jun. 16, 2005, by Edward R. Grauch, et al., and of which is hereby incorporated by reference. For example, the database records each action taken by a television subscriber, such as “volume up,” “volume down,” “mute,” “channel up,” channel down,” and many other events of interests that are stored in a database with a date-time stamp to allow tracking of the television subscriber's selection and use of programming. Thus, the auction engine 130 of the exemplary invention compares near real-time viewership information (similar to the viewership data described in U.S. patent application Ser. No. 11/154,248) with detailed auction data 332 of an advertisement bid and/or with advertising data 334 such as, advertisement genre, advertisement metadata, and other information. The matched data is then used evaluated with the business data 336 to price the auction bid and maximize a contract price to an awarded advertisement slot. The business data 336 includes data for awarding the advertisement time slot and for distributing the advertisement (e.g., data provided by a content provider to select a bid for an advertisement time slot, such as, minimum bid amount, volume pricing for a repeat advertiser, payment details (e.g., how to pay, when to pay, history of payment from a previous advertiser that may reflect credit history of advertiser), feedback mechanism for each advertiser that bids on a time slot and other business data).

When the viewership data indicates that the media content is being watched or otherwise viewed by a threshold amount of desirable viewers, the advertiser may wish to make a larger bid for the available advertisement insertion slot. Conversely, when the threshold amount of desirable viewers is low (despite a large number of media devices that are watching or viewing the advertisement), the advertiser may make a small bid or even no bid. The slot information may also determine the bid amount. The slot information describes any constraints that are imposed on the advertisement insertion slot. The slot information, for example, may describe a duration of the advertisement insertion slot, and longer durations in popular content may require larger bids. The slot information may describe whether the advertisement insertion slot will be locally, regionally, or nationally broadcasted or multi-casted. Higher bid amounts may be expected for greater distribution, while lower bid amounts may be made for unicast distribution to a relatively low number of devices. The slot information may also describe bandwidth or byte constraints that may limit what advertising content is insertable into the advertisement insertion slot. If the advertisement insertion slot can only accept a small byte-size advertisement (such as a black and white ad or a simple text ad), then the bid amount may be smaller. If the advertisement insertion slot can support a sophisticated or large byte-size advertisement (such as an MPEG color video), then the bid amount may be large.

Still further, the revenue sharing engine 340 may refine the bid amount of an advertiser. The revenue sharing engine 340 may contain one or more rules that are helpful in calculating additional revenue or other important factors to the content provider. For example, an advertiser may offer a percentage of interactive viewer sales if the matched advertisement is presented during the advertisement time slot. According to an exemplary embodiment, the advertiser may track the revenues associated with the sales of a product that was advertised using the advertisement auction system and pays the advertisement auction company a share of the revenues. And, sometimes diversity considerations might influence procurement selections. Other factors, such as switching costs, credit terms, and risk, might also be factors that can influence selection of winning bids. If value-added pricing is desired, one or more weighting factors are suggested to influence selection of a winning bidder. The weighting factor may be expressed as either a dollar amount or as a percentage decrement. When each advertiser's bid is received, the method adjusts the bid using each advertiser's corresponding weighting factor.

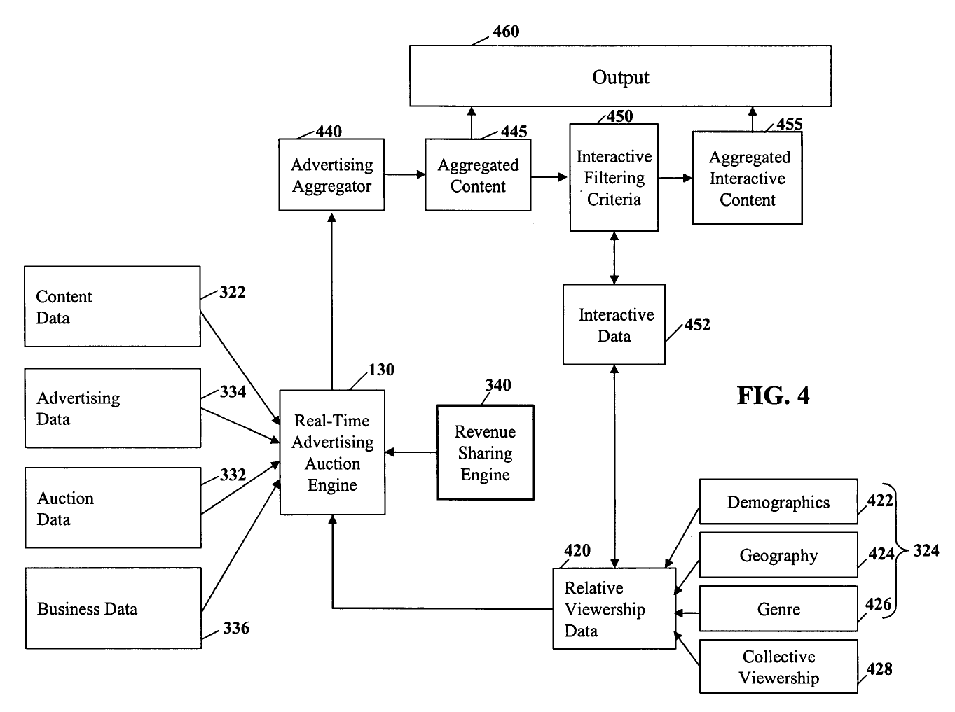

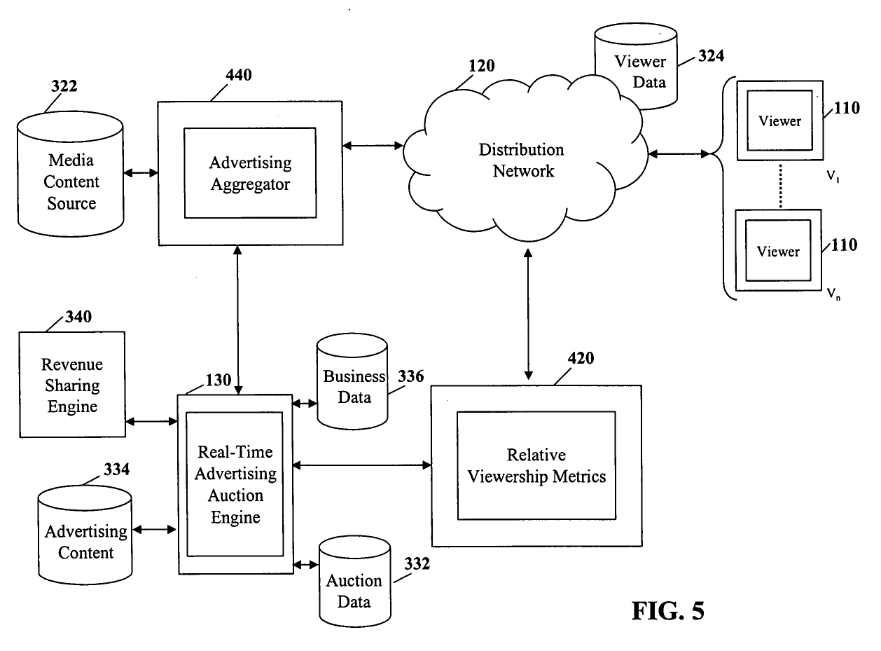

FIGS. 4 and 5 illustrate an exemplary overview of the inputs, engines, filters, and outputs of another exemplary operating system. The Auction Engine 130 receives content data 322, advertising data 334, auction data 332, business data 336, input(s) from the revenue sharing engine 340, and relative viewership data 420 that includes demographics 422, geography 424, genre, 426, and collective viewership data 428. As discussed above, these inputs are used by the Auction Engine 130 to select and award an advertisement time slot. Thereafter, the Auction Engine 130 interfaces with an advertising aggregator 440 to merge or otherwise insert the advertisement content with the media content to create aggregated content 445 that is then output 460 for presentation to the media device 110 of one or more viewers. According to a further embodiment, when the integrated content is monitored for either a subsequent event of interest or an interactive selection 452, the updated, relative viewership information may be filtered by interactive filtering criteria 450 to output 460 aggregated interactive content 455 to the media device 110. This additional step provides a feedback mechanism with actual viewership metrics and characteristics that the advertiser may use to measure effectiveness of the Auction Engine 130.

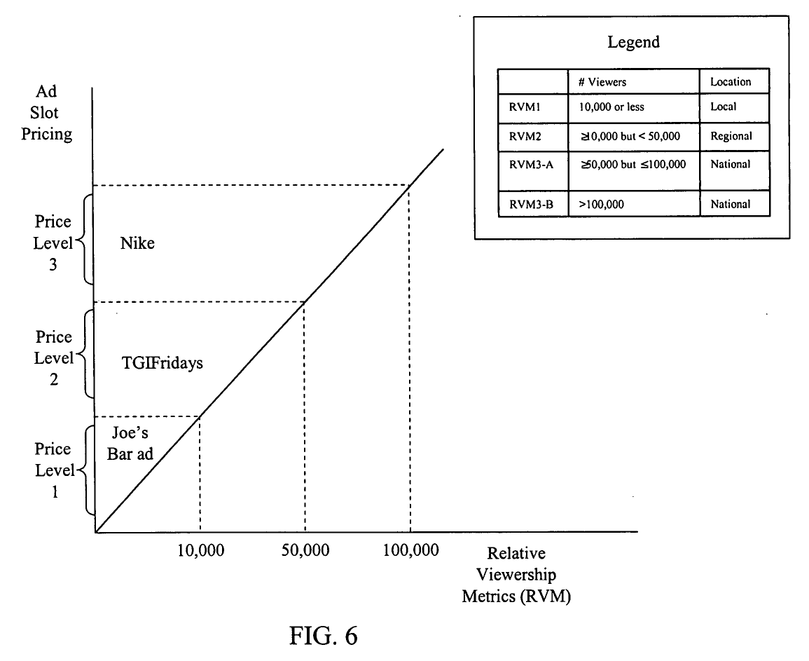

FIG. 6 depicts a graph having relative viewership metrics (RVMs) along the horizontal axis and pricing levels of three different advertisements along the vertical axis according to exemplary embodiments. The relative viewership metrics of FIG. 6 are for illustrative purposes and need not be limited to this exemplary visual representation as one of ordinary skill in the art will understand. The advertisements include an ad by Nike, an ad by TGIFridays, and an ad by a local bar known as “Joes's Bar.” This graph illustrates that Nike may have an RVM of 50,000 minimum viewers that are located anywhere (e.g., national), TGIFridays may have an RVM of more than 10,000 viewers in a specified locality (e.g., regional), and that Joe's Bar may have an RVM of less than 10,000 viewers in a smaller, specified locality (e.g., local). The relationships of these RVMs are shown as linear; however, these relationships may also be and often are non-linear. Accordingly, Joe's Bar may be willing to pay for an advertisement slot only up to a maximum price within Price Level 1; however, if the number of viewers reaches or exceeds RVM level 1 (less than 10,000 in the example of FIG. 6), then the advertisement slot becomes available for a higher bidder (TGIFriday's in this case). Likewise, TGIFriday's may be willing to pay for an advertisement slot only up to a maximum price within Price Level 2; however, if the number of viewers reaches or exceeds RVM level 2 (less than 50,000 but greater than or equal to 10,000 in the example of FIG. 6), then the advertisement slot becomes available for a higher bidder (Nike in this case). Finally, Nike may be willing to pay for an advertisement slot only up to a maximum price within Price Level 3; however, if the number of viewers reaches or exceeds RVM level 3-A (greater than or equal to 50,000 but less than or equal to 100,000 in the example of FIG. 6) and RVM level 3-B (greater than 100,000), then the advertisement slot becomes available for a higher bidder. An alternative solution would award the advertisement slot to Nike if there are no higher bidders, in which case Nike would win the advertisement slot for any level of viewership above 100,000. It is important to note that available advertisement slots may be auctioned off at or near the time when the advertisement slot becomes available based on the near real-time number of active viewers, but that the price levels provided by the advertisers may be provided in advance of the occurrence of the available time slot. The advertisers need not provide price level bids at the time that the slot becomes available.

According to further exemplary alternate embodiments, the Real Time Auction Engine compares two or more near real-time collective viewership metrics to characterize the viewership metric as one of “stable,” “unstable,” “increasing,” or “declining.” For example, a comparison of RVM3-A and RVM3-B of FIG. 6 includes collective viewership of approximately 50,000 to 100,000 viewers and collective viewership of greater than 100,000 viewers. Without considering different times of evaluation, a comparison of RVM3-A with RVM3-B may characterize the RVMs as “stable.” However, if RVM3-A is collected at time “t” and RVM3-B is collected at time “t+additional interval of time,” then the comparison may characterize the RVMs as “increasing.”

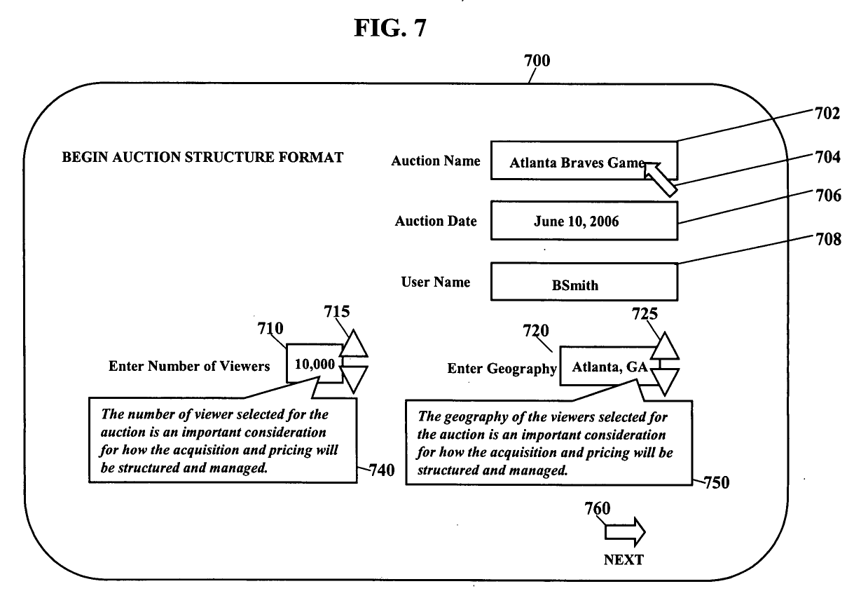

FIGS. 7-9 are schematics illustrating exemplary Graphical User Interfaces. The auction module (shown as reference numeral 130 in FIGS. 1-6) may operate within a system memory device of the computer system (shown as reference numeral 102 in FIGS. 1 and 2) and allows the advertiser to structure participation in an advertisement auction. FIG. 7 shows a representation of a first exemplary Graphical User Interface 700 that the Auction Module 130 might present to the advertiser. The Auction Module 130 presents the Graphical User Interface 700 on a display device and allows the advertiser to enter data and to make choices. The Graphical User Interface 700 may include an auction name data field 702, an auction date data field 706, a user name data field 708, a number of viewers data field 710, and a geography data field 720. According to exemplary embodiments, the advertiser places a curser 704 in the auction name data field 702 and selects an auction name that identifies an available advertisement slot during presentation of a named media content. The advertiser then places the curser 704 in the auction date data field 706 and selects a date for the available advertisement slot. The advertiser then places the curser 704 in the advertiser name data field 708 and types or otherwise enters the advertiser's name. The advertiser also places the curser 704 in the number of viewers data field 710 and may input a desired number of actual viewers or may use the up or down buttons of 715 to display a pull-down menu of choices for pre-loaded number of viewers. The advertiser also places the curser 704 in the geographic data field 720 and selects the geographic region for the available advertisement slot. Customized templates to structure a bid from an advertiser may also be available such that an advertiser could provide further details, such as genre characteristics and other information for bidding on an advertisement. The Graphical User Interface 700 may also include annotations. These annotations provide information that helps the advertiser make choices/decisions with the auction structure. FIG. 7, for example, shows an annotation 740 to describe the number of viewers and an annotation 750 to describe the geographic field 720. When the advertiser has completed this Graphical User Interface 700, the advertiser then selects a “Next” action button 760 to advance to the next inputs.

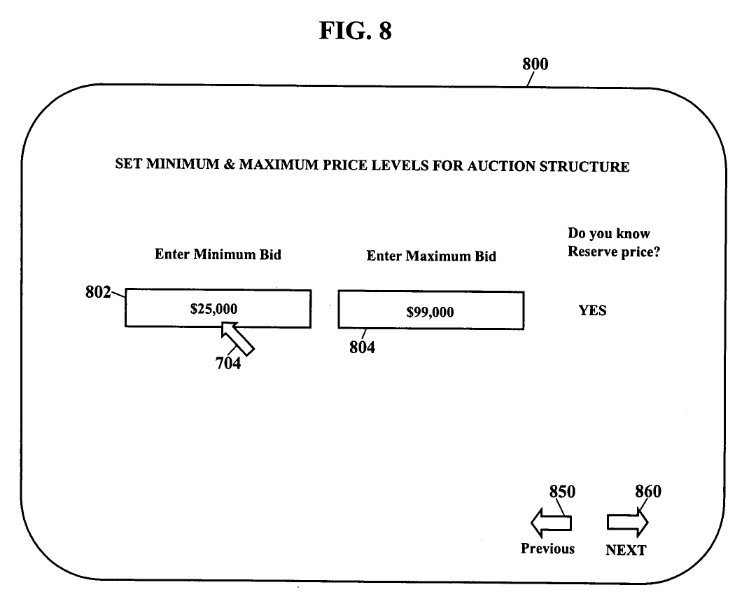

FIG. 8 shows another exemplary Graphical User Interface 800 that might be presented to the advertiser. Here the advertiser inputs pricing levels for the auction. The advertiser places the curser 704 in an enter minimum bid data field 802 and inputs minimum bid pricing for the auction. The advertiser also places the curser 704 in an enter maximum bid data field 804 and inputs the maximum bid pricing for the auction. When the advertiser has completed this second Graphical User Interface 800, the advertiser then selects a “Next” action button 860 to advance to the next inputs. If the advertiser, however, wishes to return to the previous page, the advertiser instead selects a “Previous” action button 850.

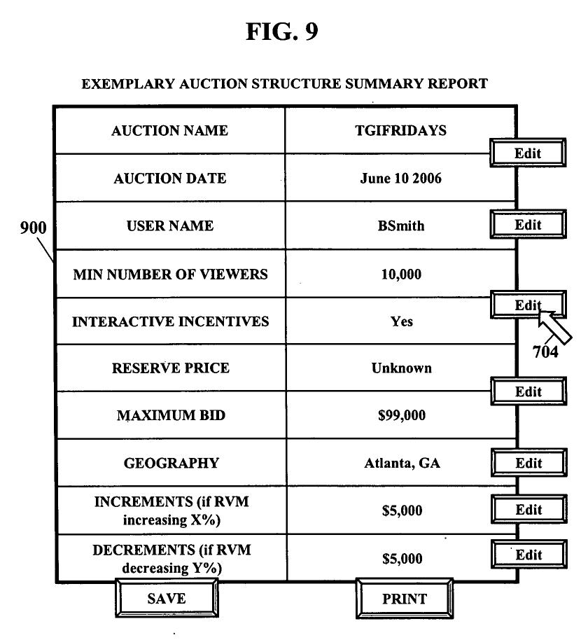

FIG. 9 shows a third exemplary Graphical User Interface 900 that presents a summary of the detailed auction inputs, selections, or other information for participation in the auction. This GUI 900 also allows the advertiser opportunities to revise/alter the inputs, selections and/or information. The GUI 900 also includes various “Edit” action buttons that return to each respective Graphical User Interface. If the advertiser wishes to revise any inputs/selections/information, the advertiser need only place the curser 704 and select the appropriate “Edit” action button. When the advertiser is satisfied with the inputs/selections/information, the advertiser can place the curser 704 and select a “SAVE” action button and/or a “PRINT” action button.

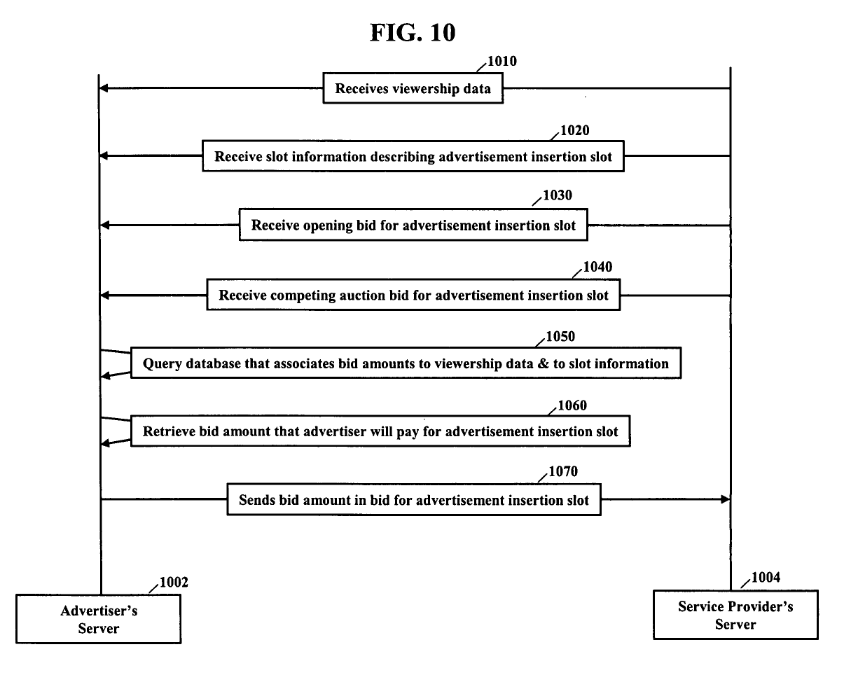

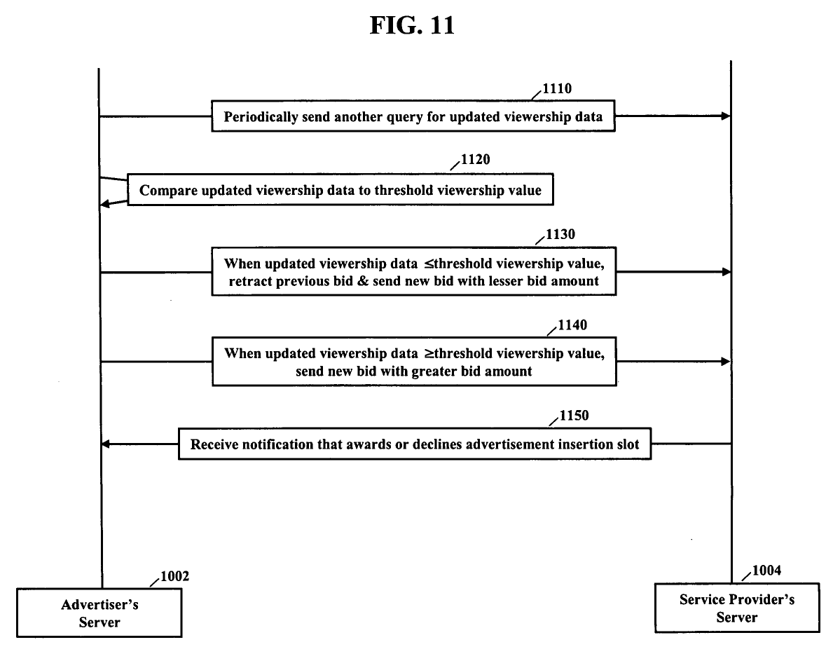

FIGS. 10 and 11 are schematics illustrating an alternative process for auctioning an advertisement time slot according to more exemplary embodiments. Here an advertiser's server 1002 may receive viewership data, such as the viewership data 420, from a service provider's server 1004 (step 1010). The viewership data 420 statistically describes a popularity of content that contains or includes the advertisement insertion slot. The advertiser's server 1002 may also receive slot information describing the advertisement insertion slot (step 1020). The advertiser's server 1002 may also receive an opening bid for the advertisement insertion slot (step 1030). The advertiser's server 1002 may also receive a competing auction bid for the advertisement insertion slot (step 1040). The competing auction bid has been submitted by another advertiser for the same advertisement insertion slot. According to exemplary embodiments, the advertiser's server 1002 queries a database that maps, relates, or otherwise associates bid amounts to the viewership data 420 and to the slot information (step 1050). The advertiser's server 1002 retrieves a bid amount that the advertiser will pay for the advertisement insertion slot (step 1060), given the viewership data 420 and any constraints described by the slot information. The advertiser's server 1002 then sends the bid amount as a bid for the advertisement insertion slot (step 1070).

The viewership data 420 may also influence pricing of the bid amount. Because the viewership data 420 provides near real-time metrics categorizing the popularity of the media content and/or other information associated with the advertisement insertion slot, the viewership data 420 may describe the number of media devices and/or viewers that are currently receiving the media content. Similar to the description above, the viewership data 420 may also describe the number of media devices that are “watching” or otherwise “viewing” the media content by deciphering and comparing event records (e.g., comparing a first event record with an event of interest to turn up the volume with a second event record with an event of interest to forward the media content for presentation to a peripheral device coupled with the media device (e.g., forwarding the presentation of the media content from an IPTV to a VoIP phone). The viewership data 420 may be expressed as a percentage of media devices watching or viewing the media content out of a total population of media devices registered or otherwise recognized to receive the media content. The viewership data 420 may be expressed by geographic region or demographic profile (e.g., age, income, sex, education). When the viewership data 420 indicates that the media content is being watched or otherwise viewed by a threshold amount of desirable viewers, the advertiser may wish to make a larger bid for the available advertisement insertion slot. Conversely, when the threshold amount of desirable viewers is low (despite a large number of media devices that are watching or viewing the advertisement), the advertiser may make a small bid or even no bid.

The slot information may also determine the bid amount. The slot information describes any constraints that are imposed on the advertisement insertion slot. The slot information, for example, may describe a duration of the advertisement insertion slot, and longer durations in popular content may require larger bids. The slot information may describe whether the advertisement insertion slot will be locally, regionally, or nationally broadcasted or multi-casted. Higher bid amounts may be expected for greater distribution, while lower bid amounts may be made for unicast distribution to a relatively low number of devices. The slot information may also describe bandwidth or byte constraints that may limit what advertising content is insertable into the advertisement insertion slot. If the advertisement insertion slot can only accept a small byte-size advertisement (such as a black and white ad or a simple text ad), then the bid amount may be smaller. If the advertisement insertion slot can support a sophisticated or large byte-size advertisement (such as an MPEG color video), then the bid amount may be large.

As FIG. 11 illustrates, the advertiser may obtain updated viewership data. After the bid amount has been sent (see step 1070 of FIG. 10), the advertiser's server 1002 may periodically send another query for updated viewership data (step 1110). Because the service provider is conducting a real-time (or near real-time) auction for the advertisement insertion slot, advertisers may wish to recursively obtain the viewership data. Viewership metrics and viewership characteristics (also referred to herein as “a viewership criterion”) may collectively increase and decrease as delivery of the media content progresses. Viewers may grow tired of content that doesn't live up to the “hype.” On the other hand, viewership may increase when an important scene approaches or when a sporting event will have a dramatic finish. For many reasons, then, advertisers may wish to obtain the most up-to-date viewership data that most accurately describes the viewers most likely to view or watch the advertisement.

As FIG. 11 illustrates, the advertiser may refine the bid amount. Whenever the advertiser's server 1002 receives the updated viewership data, the updated viewership data may be compared to a threshold viewership value (step 1120). The threshold viewership value is any configurable parameter that determines when the advertiser wishes to refine the bid amount. When, for example, the updated viewership data is less than the threshold viewership value, then the advertiser may wish to retract the previously-submitted bid. The advertiser's server 1002 may send a new bid with a lesser bid amount (step 1130). Likewise, when the updated viewership data is greater than the threshold viewership value, then the advertiser may wish to send a new bid with a greater bid amount (step 1140). This greater bid amount may reflect a larger audience of viewers watching or viewing the media content and/or a larger audience of desirable viewers having a matched viewership criterion. At the end of the auction the advertiser's server 1002 may receive a notification (step 1150). If the advertiser's server 1002 submitted the highest bid amount, then the notification may award the advertisement insertion slot. If, however, another bidder won the advertisement insertion slot, then the notification would decline to award the advertisement insertion slot.

The auction module 130 may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-users, licensees, and assignees. These types of computer-readable media, and other types not mention here but considered within the scope of the present invention, allow the auction module 130 to be easily disseminated. A computer program product for selecting a structure for an auction includes the auction module stored on the computer-readable medium. The auction module 130 may prompt an advertiser to input details of the auction.

The auction module 130 may also be physically embodied on or in any addressable (e.g., HTTP, I.E.E.E. 802.11, Wireless Application Protocol (WAP)) wireline or wireless device capable of presenting an IP address. Examples could include a computer, a wireless personal digital assistant (PDA), an Internet Protocol mobile phone, or a wireless pager.

While the present invention has been described with respect to various features, aspects, and embodiments, those skilled and unskilled in the art will recognize the invention is not so limited. Other variations, modifications, and alternative embodiments may be made without departing from the spirit and scope of the present invention.

What is claimed is:

1. A method for awarding an advertisement time slot, comprising:
accessing viewership data about a viewer's selection and use of media content, the viewership data comprising at least one viewership criterion describing one or more viewers as desirable for receiving advertisement content;
accessing an advertising auction engine to award the advertisement time slot, the advertising auction engine comprising at least one of advertising data, auction data for selecting and bidding on the advertisement time slot, and business data for awarding the advertisement time slot, the advertising auction engine for:
i) matching the viewership data with the auction data and the advertising data to identify one or more advertisements as desirable for distribution to the one or more viewers during the advertisement time slot,
ii) establishing a bid price for each of the identified one or more advertisements, the bid price adjusted by the advertising auction engine based upon the matched data for each advertisement and based upon the business data, and
iii) awarding the advertisement time slot to one of the identified one or more advertisements to maximize a contract price for the advertisement time slot.

2. The method of claim 1, further comprising:
merging the advertisement content of the awarded, identified advertisement with the media content.

3. The method of claim 2, further comprising:
communicating the merged content to a media delivery device of the one or more viewers.

4. The method of claim 1, further comprising:
communicating advertisement content associated with the awarded, identified advertisement at a presentation time for the advertisement time slot to the media delivery device of the one or more viewers.

5. The method of claim 1, the advertising auction engine further comprising a revenue sharing engine, the revenue sharing engine comprising at least one rule for calculating revenue to a content provider.

6. The method of claim 5, wherein the at least one rule for calculating revenue to a content provider comprises an estimated revenue based upon a percentage of interactive viewer sales if the matched advertisement is presented during the advertisement time slot.

7. The method of claim 6, wherein the contract price comprises the bid price and the estimated revenue.

8. The method of claim 5, wherein the at least one rule for calculating revenue to a content provider comprises a weighting factor to influence awarding of the advertisement time slot.

9. The method of claim 1, wherein the viewership criterion comprises a demographic characteristic of the one or more viewers.

10. The method of claim 1, wherein the viewership criterion comprises a genre characteristic of the one or more viewers.

11. The method of claim 1, wherein the viewership criterion comprises a geographic characteristic of the one or more viewers.

12. The method of claim 1, further comprising:
merging a plurality of viewership criterion from each viewer to determine a near real-time collective viewership metric associated with the media content.

13. The method of claim 1, wherein the viewership criterion comprises an event record, the event record comprising a command of interest from the one or more viewers and a time associated with the command of interest.

14. The method of claim 13, further comprising:
merging a plurality of event records to determine a near real-time collective viewership metric associated with the media content; and
comparing two or more near real-time collective viewership metrics to characterize the viewership metric as one of stable, unstable, increasing, or declining.

15. The method of claim 14, wherein the near real-time collective viewership metric identifies a near real-time total number of viewers of the media content.

16. The method of claim 15, wherein if the collective viewership metric is stable, then establishing an auction price that is approximately equal to a reserve price.

17. The method of claim 15, wherein if the collective viewership is declining, then establishing a contract price less than or equal to a reserve price.

18. The method claim 15, wherein if the collective viewership is increasing, then establishing a contract price that is at least equal to the reserve price.

19. A system, comprising:
a Real Time Advertising Auction Module stored in a memory device; and
a processor communicating with the memory device, the Real Time Advertising Auction Module:
i) receiving advertising auction data for bidding on one or more advertisement time slots of a content provider,
ii) receiving business data to select an advertisement for an advertisement time slot,
iii) receiving viewership data associated with a presentation of media content by the content provider,
iv) matching the viewership data with the advertising data and the auction data to identify one or more advertisements as desirable for distribution to one or more viewers during the advertisement time slot,
v) establishing a bid price for each of the identified one or more advertisements, the bid price adjusted according to the matched data for each advertisement and according to the business data for selecting the advertisement, and
vi) awarding the advertisement time slot to one of the identified one or more advertisements such that a contract price for the advertisement time slot is maximized.

20. A storage medium on which is encoded instructions for performing the following:
accessing advertising auction data for bidding on one or more advertisement time slots during presentation of media content by a content provider,
accessing business data to select an advertisement for the one or more advertisement time slots,
accessing viewership data associated with the presentation of the media content,
matching the viewership data with the advertising data and the auction data to identify one or more advertisements as desirable for distribution to one or more viewers during the advertisement time slot,
establishing a price for each of the identified one or more advertisements, the bid price adjusted by the advertising auction engine based upon the matched data for each advertisement and based upon the business data for selecting an advertisement, and
awarding the advertisement time slot to one of the one or more identified advertisements to maximize a contract price for the advertisement time slot.

21. A method for auctioning an advertisement time slot, comprising:
receiving viewership data that statistically describes a popularity of content;
receiving a duration of the advertisement time slot;
querying a database that associates bid amounts to the viewership data and to the duration of the advertisement time slot;
retrieving a bid amount; and
sending the bid amount as a bid for the advertisement insertion slot.

22. The method of claim 21, further comprising periodically querying for updated viewership data.

23. The method of claim 21, further comprising comparing the updated viewership data to a threshold viewership value.

24. The method of claim 23, wherein when the updated viewership data is less than the threshold viewership value, then sending a bid retraction that retracts the bid amount.

25. The method of claim 23, further comprising sending a new bid comprising a lesser bid amount that reflects a reduced popularity of the content.

26. The method of claim 23, wherein when the updated viewership data is greater than the threshold viewership value, then sending a bid retraction that retracts the bid amount.

27. The method of claim 23, further comprising sending a new bid comprising a greater bid amount that reflects an increased popularity of the content.

28. The method of claim 21, further comprising receiving an opening bid for the advertisement insertion slot.

29. The method of claim 21, further comprising receiving a competing auction bid for the advertisement insertion slot.

30. The method of claim 21, further comprising receiving a notification that awards the advertisement insertion slot to a highest bidder.

31. The method of claim 21, further comprising receiving a notification that another bidder won the advertisement insertion slot.
